(19) United States
(12) Patent Application Publication
(10) Pub. No.: US 2026/0062212 A1
(43) Pub. Date: Mar. 5, 2026

(54) REFUSE LOADING SYSTEM WITH PROPORTIONAL COORDINATED DUMP

(71) Applicant: The Heil Co., Chattanooga, TN (US)

(72) Inventors: Tony Lawayne Coffey, Dawson, AL (US); Stanley L. Maroney, Attalla, AL (US); Phillip A. Kendrick, Chattanooga, TN (US); Jonathan Paul Shadrick, Trenton, GA (US); Robert B. Williams, Albertville, AL (US); Macey Parris Sarratt, Collinsville, AL (US)

(21) Appl. No.: 19/306,434

(22) Filed: Aug. 21, 2025

Related U.S. Application Data
(60) Provisional application No. 63/689,189, filed on Aug. 30, 2024.

(51) Int. Cl. B65F 3/08; B65F 3/02; B65F 3/04

(52) U.S. Cl. CPC B65F 3/08; B65F 3/046; B65F 2003/023; B65F 2003/0259; B65F 2003/0269

(57) ABSTRACT

Systems and methods for collecting and loading refuse include a refuse loading system configured to couple to a refuse collection vehicle and to load refuse into the refuse collection vehicle and a control system. The refuse loading system includes a container-holding mechanism operable to hold a refuse container, and a positioning system operable to position the container-holding mechanism relative to the refuse collection vehicle. The control system includes a proportional control device, at least one processor, and memory communicably coupled to the at least one processor. The memory stores instructions which, when executed, cause the at least one processor to perform operations including receiving, from an operator, via the proportional control device, an input to control movement of one or components of the refuse loading system, and, responsive to receiving the input, operating the container-holding mechanism and the positioning system to perform a portion of a refuse loading cycle.

### CROSS-REFERENCE TO RELATED APPLICATION

This application claims the benefit under 35 U.S.C. § 119 (c) of U.S. Patent Application No. 63/689,189, entitled “Refuse Loading System With Proportional Coordinated Dump,” filed Aug. 30, 2024, which is incorporated herein by reference in its entirety.

### BACKGROUND

Mechanical arms are used to perform the automated collection of garbage bins. In a typical configuration, such a mechanical arm is supported for transport on the mobile chassis of a refuse collection vehicle (RCV) and designed to dump the contents of a garbage bin into the RCV's storage container. The components and sub-systems used in these mechanical arms are large, heavy, and noisy, and they impart significant vibration and impact loads on both the refuse vehicle and its human operators. As a result, the arms often suffer from mechanical efficiency or durability issues while the human operators experience physical burdens (e.g., driver fatigue). The human operators also face the additional challenge of managing operations of the mechanical arms around nearby objects (e.g., parked vehicles, overhanging tree limbs, brush, mailboxes, or other bins).

### SUMMARY

Aspects of the present disclosure are generally directed to systems and methods for loading refuse into refuse collection vehicle.

In one aspect, a system for collecting refuse includes a refuse loading system configured to couple to a refuse collection vehicle and to load refuse into the refuse collection vehicle. The refuse loading system includes: a container-holding mechanism operable to hold a refuse container; and a positioning system operable to position the container-holding mechanism relative to the refuse collection vehicle; and a control system. The control system includes: a proportional control device, at least one processor, memory communicably coupled to the at least one processor. The memory stores instructions which, when executed, cause the at least one processor to perform operations including: receiving, from an operator, via the proportional control device, an input to control movement of one or more components of the refuse loading system; and responsive to receiving the input from the operator via the proportional control device, operating the container-holding mechanism and the positioning system to perform a portion of a refuse loading cycle.

In another aspect combinable with the previous aspect, the portion of the refuse loading cycle includes one of a coordinated dump and auto-lift operation.

In another aspect combinable with one or more of the previous aspects, the container-holding mechanism includes a container-lifting device, and the control system is configured to control the speed of one or more components of the container-lifting device responsive to receiving the input via the proportional control device.

In another aspect combinable with one or more of the previous aspects, the container-holding mechanism includes a grabber, and the control system is configured to control the speed of one or more components of the grabber responsive to receiving the input via the proportional control device.

In another aspect combinable with one or more of the previous aspects, the positioning system includes a horizontal positioning system, and the control system is configured to control the speed of one or more components of the horizontal positioning system responsive to receiving the input via the proportional control device.

In another aspect combinable with one or more of the previous aspects, the proportional control device includes an analog proportional control button.

In another aspect combinable with one or more of the previous aspects, movement of one or more components of the container-holding mechanism during the portion of the refuse loading cycle is coordinated with positioning of the container-holding mechanism by the positioning system.

In another aspect combinable with one or more of the previous aspects, the memory further stores instructions executable by the processor to perform: receiving, from the operator, via the proportional control device, a change in input to control movement of one or more components of the refuse loading system; and responsive to receiving the change in input, adjusting a speed of one or more components of the container-holding mechanism and one or more components of the positioning system. As one example, adjusting the speed of at least one of the components includes slowing down at least one of the one or more components of the container-holding mechanism and at least one of the one or more components of the positioning system. As one example, adjusting the speed of at least one of the components includes speeding up at least one of the one or more components of the container-holding mechanism and at least one of the one or more components of the positioning system.

In another aspect combinable with one or more of the previous aspects, the container-holding mechanism includes a container-lifting device, and the positioning system includes a horizontal positioning system. Additionally, the memory further stores instructions executable by the processor to perform: during a container-dumping portion of the refuse loading cycle, adjusting the speed of one or more components of the container lifting device and the speed of retraction of one or more components of the horizontal positioning system in response to the input from the operator via the proportional control device.

In another aspect combinable with one or more of the previous aspects, the container-holding mechanism includes a grabber, and the positioning system includes a horizontal positioning system. Additionally, the memory further stores instructions executable by the processor to perform: during a container-capture portion of the refuse loading cycle, adjusting the speed of one or more components of the grabber and the speed of one or more components of the horizontal positioning system in response to the input from the operator via the proportional control device.

In another aspect combinable with one or more of the previous aspects, the container-holding mechanism includes a grabber, and the positioning system includes a lifting arm. Additionally, the memory further stores instructions executable by the processor to perform: adjusting the speed of one or more components of the grabber and the speed of one or more components of the lifting arm in response to the input from the operator via the proportional control device.

In another aspect combinable with one or more of the previous aspects, the container-holding mechanism includes a grabber and a container lift mechanism, and the positioning system includes a horizontal positioning system.

In another aspect combinable with one or more of the previous aspects, the system further includes one or more sensors communicatively coupled to the control system, the one or more sensors configured to detect objects around the refuse collection vehicle. Additionally, the memory further stores instructions executable by the processor to perform: receiving data from at least one of the sensors about one or more objects detected around the refuse collection vehicle; and responsive to receiving the data from the at least one sensor about one or more objects detected around the refuse collection vehicle, determining whether at least one of the objects is a potential obstacle for the refuse container or a component of the refuse loading system during the portion of the refuse loading cycle. As one example, the memory further stores instructions executable by the processor to perform: responsive to determining that at least one of the objects is a potential obstacle, activating a reduced speed mode of the refuse loading system. As one example, the memory further stores instructions executable by the processor to perform: responsive to determining that at least one of the objects is a potential obstacle, inhibiting movement of one or more components of the refuse loading system for at least a portion of the refuse loading cycle. As one example, the memory further stores instructions executable by the processor to perform: determining whether the refuse container or component of the refuse loading system is clear of the potential obstacle; and responsive to determining that the refuse container or component of the refuse loading system is clear of the potential obstacle, increasing the speed of one or more components of the refuse loading system.

In another aspect combinable with one or more of the previous aspects, the control system includes a display screen configured to display potential obstacles for the refuse loading system.

In another aspect combinable with one or more of the previous aspects, the control system is configured to provide, to the operator, a warning of potential obstacles for the refuse loading system.

In another aspect combinable with one or more of the previous aspects, the refuse loading system includes one or more electric motors.

In another aspect combinable with one or more of the previous aspects, the refuse loading system includes one or more hydraulic actuators.

In one aspect, a method for loading refuse into a refuse collection vehicle is performed by at least one processor and includes the operations of: receiving, from an operator, via a proportional control device, an input to control movement of one or more components of a refuse loading system; and responsive to receiving the input from the operator via the proportional control device, operating a container-holding mechanism and a positioning system of the refuse loading system to perform a portion of a refuse loading cycle.

In one aspect, a system for collecting refuse includes a refuse loading system configured to couple to a refuse collection vehicle and to load refuse into the refuse collection vehicle. The refuse loading system includes: one or more sensors configured to detect objects around the refuse collection vehicle and a control system. The control system includes at least one processor and memory communicably coupled to the at least one processor, the memory storing instructions which, when executed, cause the at least one processor to perform operations including: receiving data from at least one of the sensors about one or more objects detected around the refuse collection vehicle; responsive to receiving the data from the at least one sensor about one or more objects detected around the refuse collection vehicle, determining whether at least one of the objects is a potential obstacle for a refuse container or a component of the refuse loading system during a portion of a refuse loading cycle; and responsive to determining whether at least one of the objects is a potential obstacle for the refuse container or a component of the refuse loading system, adjusting a speed of at least one component of the refuse loading system during the portion of the refuse loading cycle.

In another aspect combinable with one or more of the previous aspects, at least one of the sensors includes an object recognition sensor.

In another aspect combinable with one or more of the previous aspects, at least one of the sensors includes a camera.

In another aspect combinable with one or more of the previous aspects, the portion of the refuse loading cycle includes a coordinated dump/auto-lift operation.

In another aspect combinable with one or more of the previous aspects, adjusting a speed of at least one component during the portion of the refuse loading cycle includes reducing the speed of at least one component of a container-lifting device.

In another aspect combinable with one or more of the previous aspects, adjusting a speed of at least one component during the portion of the refuse loading cycle includes reducing the speed of at least one component of a grabber.

In another aspect combinable with one or more of the previous aspects, adjusting a speed of at least one component during the portion of the refuse loading cycle includes reducing the speed of at least one component of a horizontal positioning system.

In another aspect combinable with one or more of the previous aspects, the operations performed by the processor further include, responsive to determining that at least one of the objects is a potential obstacle, activating a reduced speed mode of the refuse loading system. As one example, activating the reduced speed mode limits operation of the refuse loading system to input from a proportional control device. As another example, activating the reduced speed mode reduces the speed of one or more components for at least a portion of the refuse loading cycle.

In another aspect combinable with one or more of the previous aspects, the memory further stores instructions executable by the processor to perform: responsive to determining that at least one of the objects is a potential obstacle, inhibiting movement of one or more components of the refuse loading system for at least a portion of the refuse loading cycle.

In another aspect combinable with one or more of the previous aspects, the memory further stores instructions executable by the processor to perform: responsive to determining that at least one of the objects is a potential obstacle, disabling movement of one or more components of the refuse loading system for at least a portion of the refuse loading cycle.

In another aspect combinable with one or more of the previous aspects, the memory further stores instructions executable by the processor to perform: determining whether a refuse container or component of the refuse loading system is clear of the potential obstacle; and responsive to determining that the refuse container or component of the refuse loading system is clear of the potential obstacle, increasing the speed of one or more components of the refuse loading system.

In another aspect combinable with one or more of the previous aspects, the potential obstacle is an object on the ground.

In another aspect combinable with one or more of the previous aspects, the potential obstacle is an overhead object.

In another aspect combinable with one or more of the previous aspects, the potential obstacle is a moving object.

In another aspect combinable with one or more of the previous aspects, the control system further includes a proportional control device, adjusting a speed of at least one component during the portion of the refuse loading cycle includes the operations of: receiving, from an operator, via the proportional control device, an input to control movement of one or more components of the refuse loading system; and responsive to receiving the input from the operator via the proportional control device, operating the refuse loading system to perform a portion of a refuse loading cycle.

In another aspect combinable with one or more of the previous aspects, movement of one or more components of a container-holding mechanism of the refuse loading system during the portion of the refuse loading cycle is coordinated with positioning of the container-holding mechanism by a positioning system of the refuse loading system.

In another aspect combinable with one or more of the previous aspects, the control system includes a display screen configured to display potential obstacles for the refuse loading system.

In another aspect combinable with one or more of the previous aspects, the control system is configured to provide, to the operator, a warning of potential obstacles for the refuse loading system.

In one aspect, a method for loading refuse into a refuse collection vehicle is performed by at least one processor and includes the operations of: receiving data from at least one sensor about one or more objects detected around the refuse collection vehicle; responsive to receiving the data from the at least one sensor about one or more objects detected around the refuse collection vehicle, determining whether at least one of the objects is a potential obstacle for a refuse container or a component of the refuse loading system during a portion of a refuse loading cycle; and responsive to determining whether at least one of the objects is a potential obstacle for the refuse container or a component of the refuse loading system, adjusting a speed of at least one component of the refuse loading system during the portion of the refuse loading cycle.

Particular implementations of the subject matter described in this specification can be implemented so as to realize one or more of the following advantages.

Implementations of the present disclosure may reduce a risk of damage to a refuse loading system from collisions with objects around a refuse collection vehicle.

Implementations of the present disclosure may reduce a risk of damage to property around a refuse collection vehicle during loading of refuse into the refuse collection vehicle.

Implementations of the present disclosure may reduce a risk of injury to operators and other persons around a refuse collection vehicle during loading of refuse into the refuse collection vehicle.

Implementations of the present disclosure may increase safety of operating a refuse loading system.

Implementations of the present disclosure may reduce delays in refuse collection caused by objects around a refuse collection vehicle during loading.

Implementations of the present disclosure may reduce discomfort, noise, jarring, vibration, and other physical burdens encountered by operators of refuse collection vehicles.

Implementations of the present disclosure may reduce operator fatigue.

Implementations of the present disclosure may increase effectiveness of loading refuse into a waste collection system.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a side view of a refuse vehicle that includes a refuse loading system according to some implementations.

FIG. 2 is a perspective view of a refuse loading system according to some implementations.

FIG. 3 is a side view of a refuse vehicle that illustrates use of a refuse loading system with proportional control and object recognition according to some implementations.

FIG. 4 is a side view of a refuse loading system with a lift mechanism and object sensors according to some implementations.

FIG. 5 is a perspective front view of a side-loading refuse vehicle with a grabber and lift arm according to some implementations.

FIG. 6 is a perspective side view the side-loading refuse vehicle of FIG. 5 during a loading cycle according to some implementations.

FIG. 7 is a top view of a refuse loading system for an intermediate container according to some implementations.

FIG. 8 is schematic diagram of a refuse vehicle with proportional control and obstacle detection according to some implementations.

FIG. 9 is a front view of a control panel for an operator to control a refuse loading system according to some implementations.

FIG. 10 depicts an example computing system, according to implementations of the present disclosure.

### DETAILED DESCRIPTION

Implementations of the present disclosure are directed to systems, devices, and methods for loading refuse. In some implementations, a refuse loading system includes proportional control. The proportional control can be used by an operator to control the speed of components of the refuse loading system.

In various implementations, an operator uses the proportional control to control the speed of two or more coordinated mechanisms during an automated loading cycle (often referred to as a “dump cycle” or a “lift cycle”). For example, the proportional control can reduce the lift rate of a container lift mechanism and the retraction rate of a horizontal positioning system by the same amount. As another example, the proportional control can reduce the extension rate of a horizontal positioning system and the rate of closing of grabber arms by the same amount.

In some implementations, the system includes object detection devices. The object detection devices can output data that is used to provide images, notifications, and/or other information to an operator about potential obstacles around the vehicle that could interfere with operation of the refuse loading system. In some implementations, the object detection devices include object recognition sensors.

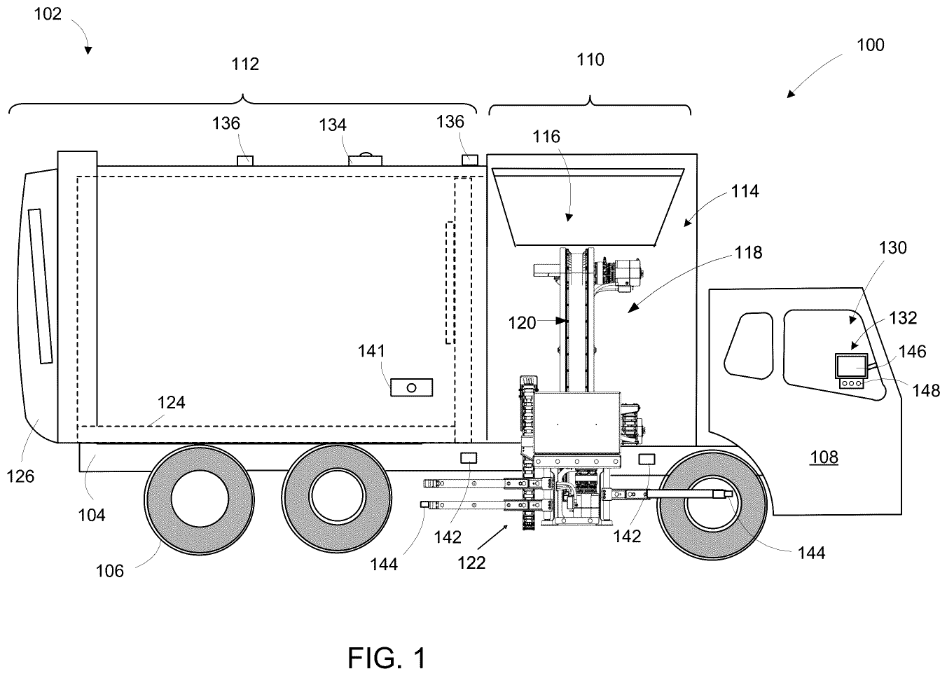

FIG. 1 illustrates a refuse vehicle that includes a refuse loading system according to some implementations. Refuse vehicle 100 includes waste collection device 102, frame 104, wheels 106, and cab 108. Waste collection device 102 includes waste intake portion 110 and waste storage portion 112.

Waste intake portion 110 includes refuse loading system 114 and hopper 116. Refuse loading system 114 is operable to transfer the contents of refuse containers into waste collection device 102 via hopper 116. Waste collection device can include a packing device (not shown in FIG. 1). The packing device can pack refuse loaded into the hopper, push refuse toward the rear of the refuse vehicle (e.g., to waste storage portion 112), and/or eject refuse from the refuse vehicle.

Refuse loading system 114 includes refuse container emptying system 118. Refuse container emptying system 118 includes container lift mechanism 120 and grabber system 122. Grabber system 122 can be operated to couple to a refuse container (e.g., a customer's garbage bin). Container lift mechanism 120 can be operated to lift the refuse container and tip and dump contents of the refuse container into hopper 116.

Refuse vehicle 100 further includes a variety of devices to monitor its surrounding environment. For example, here, refuse vehicle 100 includes upper camera 134, upper object sensors 136, lower camera 141, lower object sensors 142, and proximity sensors 144. Upper camera 134 and upper object sensors 136 are mounted to the top of refuse vehicle 100. Lower camera 141 and lower object sensors 142 are mounted on the curb side of refuse vehicle 100. In some implementations, upper object sensors 136 and lower object sensors 142 are object recognition sensors. Proximity sensors 144 are mounted near the tips of the opposing arms of grabber system 122.

Refuse vehicle 100 can be a refuse collection vehicle (RCV) that operates to collect and transport refuse (e.g., garbage). The refuse collection vehicle can also be described as a garbage collection vehicle, or garbage truck. Refuse vehicle 100 can be configured to lift containers that contain refuse and empty the refuse in the containers into a hopper of the refuse vehicle 100 and/or intermediate collection device conveyed by the RCV, to enable transport of the refuse to a collection site, compacting of the refuse, and/or other refuse handling activities. Refuse vehicle 100 can also handle containers in other ways, such as by transporting the containers to another site for emptying.

In some implementations, refuse vehicle 100 is an all-electric vehicle. Motive power and various body controls and sub-systems on the vehicle (including refuse loading system 114, a packing system, an ejector system, a contamination detection system) can be electrically powered.

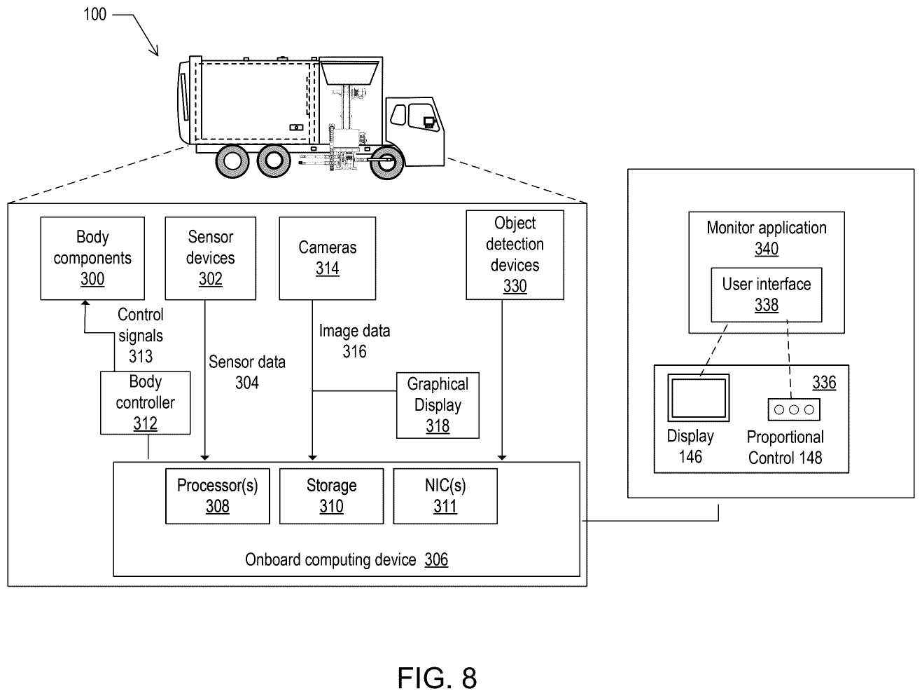

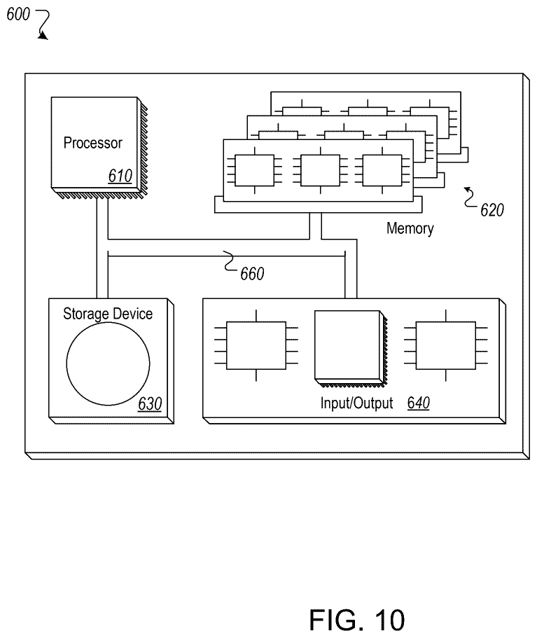

Refuse loading system 114 includes loader control system 130. Loader control system 130 includes control panel 132. Control panel 132 includes display device 146 and button panel 148. One or more of buttons of button panel 148 can be, in various implementations, a proportional control button (described further below). Control panel 132 can be mounted in cab 108. In various implementations, display device 146, button panel 148, or both can be removable from cab 108. In some implementations, control panel 132 is coupled to a main control unit (see system 600 at FIG. 10 and onboard computing device 306 and/or body controller 312 at FIG. 8), such as an onboard PLC controller or a remote computing device, by way of a wired or wireless connection.

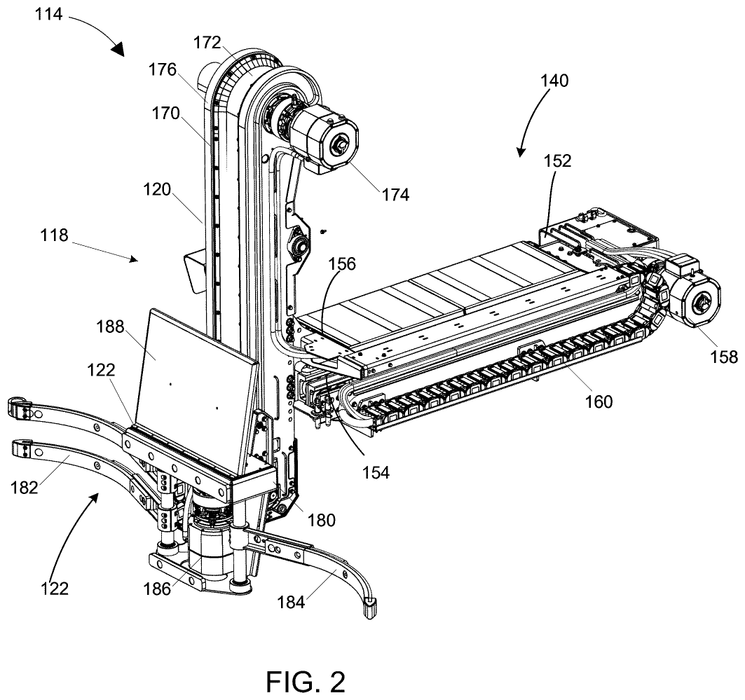

FIG. 2 is a perspective view of a refuse loading system according to some implementations. Refuse loading system 114 includes horizontal positioning system 140 and refuse container emptying system 118. Refuse container emptying system 118 includes container lift mechanism 120 and grabber 122. Horizontal positioning system 140 is mounted to the frame of the refuse vehicle 100 (not shown in FIG. 2). Horizontal positioning system 140 can be operated to position refuse container emptying system 118 relative to the body of refuse vehicle 100. Horizontal positioning system 140 can have a retracted position and one or more extended positions. Horizontal positioning system 140 can be operated to position refuse container emptying system 118 directly in front of a refuse container so that the refuse container can be lifted and such that the contents of the refuse container can be emptied into hopper 116.

Horizontal positioning system 140 includes base section assembly 152, intermediate section assembly 154, distal section assembly 156, drive unit 158, and cable system 160. Base section assembly 152 is mounted to the frame of refuse vehicle 100. Horizontal positioning system 140 can be installed such that it is partially or completely underneath hopper 116. Intermediate section assembly 154 is translatably coupled to base section assembly 152. Distal section assembly 156 is translatably coupled to intermediate section assembly 154. Refuse container emptying system 118 is mounted on distal section assembly 156.

Intermediate section assembly 154 is coupled for translation in and out on base section assembly 152. In this manner, refuse container emptying system 118 can be alternately positioned farther from, or closer to, the body of refuse vehicle 100. For example, refuse container emptying system 118 can be extended out to where a curb-side refuse container is situated for pick up.

Distal section assembly 156 is coupled for translation in and out on intermediate section assembly 154. Refuse loading system 114 is fully extended when intermediate section assembly 154 is fully extended on base section assembly 152 and distal section assembly 156 is fully extended on intermediate section assembly 154. Drive unit 158 can be operated to extend and retract refuse loading system 114. In some implementations, horizontal positioning system 140 includes an encoder device monitoring the angular position of the motor shaft. The angular position of the motor shaft is correlated to the horizontal position of base section assembly 152, intermediate section assembly 154, and/or distal section assembly 156. For instance, in a particular implementation, the encoder outputs analog or digital data reflecting the angular position of the motor shaft to the main control unit (see system 600 at FIG. 10 and onboard computing device 306 and/or body controller 312 at FIG. 8), and the main control unit performs a calculation to convert the motor shaft position data into horizontal position data regarding base section assembly 152, intermediate section assembly 154, and/or distal section assembly 156. In this way, the main control unit is able to determine when refuse loading system 114 is in a fully retracted position, a fully extended position, or some intermediate position. Similarly, by tracking the horizontal position over time, the main control unit can determine, and thus govern, the horizontal speed.

Refuse container emptying system 118 includes container lift mechanism 120 and grabber system 122. Grabber system 122 is coupled to container lift mechanism 120. Grabber system 122 can be operated to couple to a refuse container. Container lift mechanism 120 is bolted to distal section assembly 156 of horizontal positioning system 140. Container lift mechanism 120 can be operated to lift the refuse container and tip and dump contents of the refuse container into hopper 116 (shown in FIG. 1).

Container lift mechanism 120 includes mast 170, belt system 172, and vertical drive unit 174. Grabber system 122 is coupled to belt system 172 and travels along mast 170 with movement of belt system 172. Vertical drive unit 174 is coupled to drive movement of belt system 172. Accordingly, vertical drive unit 174 is operable to move belt system 172 to raise and lower grabber system 122 along mast 170.

Mast 170 includes guides 176 having a vertically straight portion that transitions to a curved portion that extends further upward and bends in the direction of hopper 116. Initially, driven by vertical drive unit 174 and belt system 172, the grabber system 122 is raised straight upward as roller assemblies on either side of grabber system 122 travel through the straight portion of guides 176. As the roller assemblies pass into the curved portion of guides 176, grabber system 122 follows a concave path along the bend. As a result, a refuse container held by grabber system 122 partially inverts, tipping the refuse container such that its contents are dumped into the refuse vehicle's hopper 116. In some implementations, an encoder device is coupled to the output shaft assembly. The encoder device can sense angular position of the motor shaft. The angular position of the motor shaft is correlated to the vertical position of grabber system 122. For instance, in a particular implementation, the encoder outputs analog or digital data reflecting the angular position of the motor shaft to the main control unit (see system 600 at FIG. 10 and onboard computing device 306 and/or body controller 312 at FIG. 8), and the main control unit performs a calculation to convert the motor shaft position data into vertical position data regarding grabber system 122. In this way, the main control unit is able to determine when grabber system 122 is in a lower position, a raised/dump position, or some intermediate position. Similarly, by tracking the vertical position over time, the main control unit can determine, and thus govern, the vertical speed.

Grabber system 122 includes frame 180, left gripper arm assembly 182, right gripper arm assembly 184, grabber drive mechanism 186, and debris shield 188. Left gripper arm assembly 182 and right gripper arm assembly 184 are coupled to frame 180 such that left gripper arm assembly 182 and right gripper arm assembly 184 can swing/pivot on frame 180 to close on a refuse container.

Any or all of the horizontal position system, the container lift mechanism, and the grabber system can include a braking device. A braking device can be operably coupled to the main control unit (see system 600 at FIG. 10 and onboard computing device 306 and/or body controller 312 at FIG. 8). In some implementations, the braking device is provided in the form of a motor braking device. In other implementations, the braking device is separate from the motor (for example, a brake that engages a rail of distal section to arrest motion of the distal section).

Sensors can be included on various components of a refuse loading system, including, for example, a horizontal positioning system, a container lift mechanism, and/or a grabber system. A refuse loading system can include various other sensors. For example, a refuse loading system can include load sensors, proximity switches, position sensors, angle sensors, or pressure sensors. Operation of the refuse loading system or other systems can be controlled based on the information provided by the sensors. In some implementations, a refuse collection system includes sensors to sense position, angle, load, or other characteristics about the system. As an example, a sensor can sense the relative or absolute position of component of a horizontal positioning system (e.g., a distal section or an intermediate section). As another example, a sensor can sense the relative or absolute position of a grabber system on a container lift mechanism. As another example, a grabber system can include a proximity switch that senses the position of a gripper arm of a grabber or a refuse container.

Control of a refuse collection device may be carried out manually, automatically, or a combination thereof. In some implementations, the main control unit (see system 600 at FIG. 10 and onboard computing device 306 and/or body controller 312 at FIG. 8) collects data from refuse collection system sensors and/or other operational sensors and automatically controls the refuse collection system or other components of the vehicle based on the information. For example, the main control unit may automatically shut down or reduce the speed of a drive system if a load (or another measured characteristic of the refuse vehicle's system) is outside an established range or exceeds an established threshold.

In some implementations, torque, speed, or other parameters are adjusted based on the position, load, or other characteristics of one or more components of a refuse loading system. For example, in certain implementations, the torque of the motor, energy consumption, or other operating parameters are adjusted to account for different loads. Operation of loading system for collecting recycled material can, for example, be different than operation of the loading system for collecting trash. In some implementations, the rate of motion of one or more components of the refuse loading system can be controlled. In some implementations, a system includes interlocks to prevent unintended or un-commanded movement.

In some implementations, the main control unit receives position feedback from motor movement (e.g., using a sensored motor in time with the belt, position of in/out or up/down can be determined mathematically from rotation/partial rotation of motor and belt pitch).

In some implementations, the main control unit controls the above-described horizontal positioning system 140, container lift mechanism 120, and grabber system 122 to perform an automatic loading cycle. The automatic loading cycle includes: (i) moving grabber system 122 outward away from the side of the vehicle 100 and toward a refuse container by extending the horizontal positioning system 140; (ii) engaging the refuse container with grabber system 122; (iii) moving grabber system 122 and the container back toward the vehicle by retracting the horizontal positioning system 140; (iv) lifting/raising the grabber system 122 and the container via container lift mechanism 120; and (v) dumping the contents of the container into hopper 116 via container lift mechanism 120. One or more of these operations can be performed sequentially or in a parallel coordinated fashion.

For example, in some implementations, the main control unit controls horizontal positioning system 140 to retract while simultaneously controlling container lift mechanism 120 to raise grabber system 122 and the container toward the dump position. Additionally, by tracking and regulating speed and position, the main control unit coordinates the movement of horizontal positioning system 140 and container lift mechanism 120 during the simultaneous retracting and raising of grabber system 122 to create a trajectory where grabber system 122 arrives in the dump position just as it is brought near enough to hopper 116 for the contents of the container to fall into hopper 116 with little to no spillage. The main control unit may regulate the speed of container lift mechanism 120 based on the distance horizontal positioning system 140 has extended for grabber system 122 to reach the container. To illustrate, in a scenario where horizontal positioning system 140 extends to 12 feet, the main control unit will control container lift mechanism 120 to raise grabber system 122 more slowly than in a different scenario where horizontal positioning system 140 extends to 6 feet.

In various implementations described above, devices are powered electrically. In certain implementations, however, devices used to operate components of a refuse loading system (such as a horizontal positioning system, a lift mechanism, and/or a grabber system) can be activated or powered in other manners, such as pneumatically, mechanically, or hydraulically.

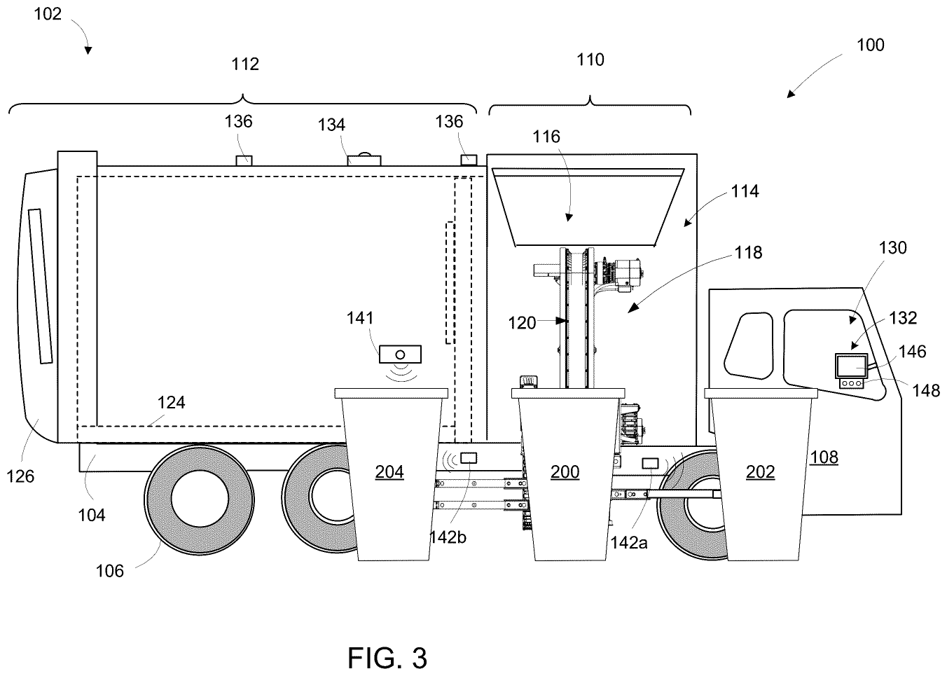

FIG. 3 illustrates use of a refuse loading system with proportional control and object recognition according to some implementations. Refuse vehicle 100 is positioned alongside a target refuse container 200 on a ground surface (e.g., the street of a residential neighborhood) so that refuse loading system 114 can be used to load refuse from target refuse container 200 into hopper 116. Another refuse container 202 is sitting on the street in front of target refuse container 200. And yet another refuse container 204 is sitting on the street behind target refuse container 200.

Loader control system 130 includes control panel 132. Control panel 132 includes display device 146 and button panel 148. In this example, at least one of the buttons on button panel 148 is a proportional control. In some implementations, the proportional control overrides an automatic loading cycle of the refuse loading system.

The proportional control button facilitates user-directed proportional control (also called “analog control”) of one or more components of refuse loading system 114 that move in a coordinated manner. In other words, a characteristic of the movement of the component(s)—such as their speed—is regulated in proportion to the degree of user-actuation of the button. A light or shallow actuation of the proportional control button may initiate relatively slow coordinated movement of the component(s). A hard or deep actuation of the proportional control button may initiate relatively fast coordinated movement of the component(s). And an intermediate actuation of the proportional control button (i.e., between light and hard) may initiate coordinated movement of the component(s) at a corresponding/proportional intermediate speed (i.e., between fast and slow). In this way, the proportional control button allows the operator to easily and intuitively control the speed (or some other aspect) of refuse loading system 114 while the main control unit continues to coordinate the trajectory and movement of the individual components.

In some implementations, the proportional control button facilitates user-directed proportional control of the above-described coordinated retracting and raising of horizontal positioning system 140 and container lift mechanism 120. A light or shallow actuation of the proportional control button causes the main control unit to coordinate the movement of horizontal positioning system 140 and container lift mechanism 120 at a relatively low speed (e.g., a speed lower than that of an automatic loading cycle). A hard or deep actuation of the proportional control button causes the main control unit to coordinate the movement of horizontal positioning system 140 and container lift mechanism 120 at a relatively fast speed (e.g., a speed equal to or greater than that of an automatic loading cycle). And intermediate actuation of the proportional control button causes the main control unit to coordinate the movement of horizontal positioning system 140 and container lift mechanism 120 at a corresponding/proportional intermediate speed.

In some implementations, the proportional speed control is uniform between multiple components moving in a coordinated fashion. For example, in response to a light/shallow touch of the proportional control button during operation of refuse loading system 114, the degree of the reduction in the rate of retraction of horizontal positioning system 140 to move the lift mechanism 120 closer to the vehicle can be the same as the degree of the reduction in the rate of lifting of the refuse container by container lift mechanism 120 to dump the contents of the container into the hopper.

Loader control system 130 and/or main control unit (see system 600 at FIG. 10 and onboard computing device 306 and/or body controller 312 at FIG. 8) can be used to determine that refuse container 202 and refuse container 204 are potential obstacles to use of refuse loading system 114 to load the contents of target refuse container 200 into hopper 116. For example, based on information from object sensor 142a, the system(s) can determine that refuse container 202 is a potential obstacle to loading target refuse container 200. Based on information from object sensor 142b, the system(s) can determine that refuse container 204 is also a potential obstacle to loading target refuse container 200. Alternatively, lower camera 141 can capture an image of any or all of the containers. Based on the images, the system(s) can determine that one or both of refuse container 202 and refuse container 204 are potential obstacles.

Upon recognition of a potential obstacle, the operator of refuse loading system 114 can use the proportional control button on button panel 148 to control the speed of one or more components of the refuse loading system. For example, the operator may use the proportional control button to slow or suspend movement of one or more components of the refuse loading system to prevent a collision with a potential obstacle. In some implementations, the system can enter a reduced speed mode. In one example, the reduced speed mode deactivates an automatic loading cycle and turns over control of performing loading operations to a human operator using the proportional control button. In another example, the reduced speed mode modifies the automatic loading cycle by reducing the speed or suspending the movement of one or more components of the refuse loading system.

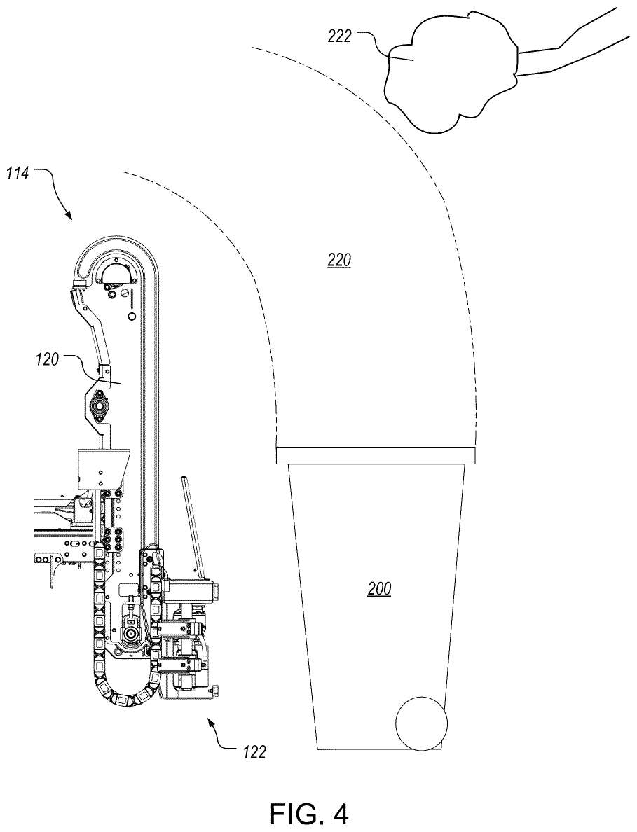

FIG. 4 is a side view of a refuse loading system with a lift mechanism and object sensors according to some implementations. Grabber system 122 of refuse loading system 114 is operable to couple with refuse container 200. Container lift mechanism 120 is operable to lift refuse container 200 such that the contents of refuse container are emptied into the refuse vehicle. Object detection devices on the refuse vehicle can gather data regarding objects that may be in the path 220 of the container or components of the refuse loading system during a loading cycle, such as tree limb 222. As discussed, loader control system 130 can include a proportional control to operate lift mechanism 120 and/or other components of the refuse loading system at a reduced speed, adjustable by the operator.

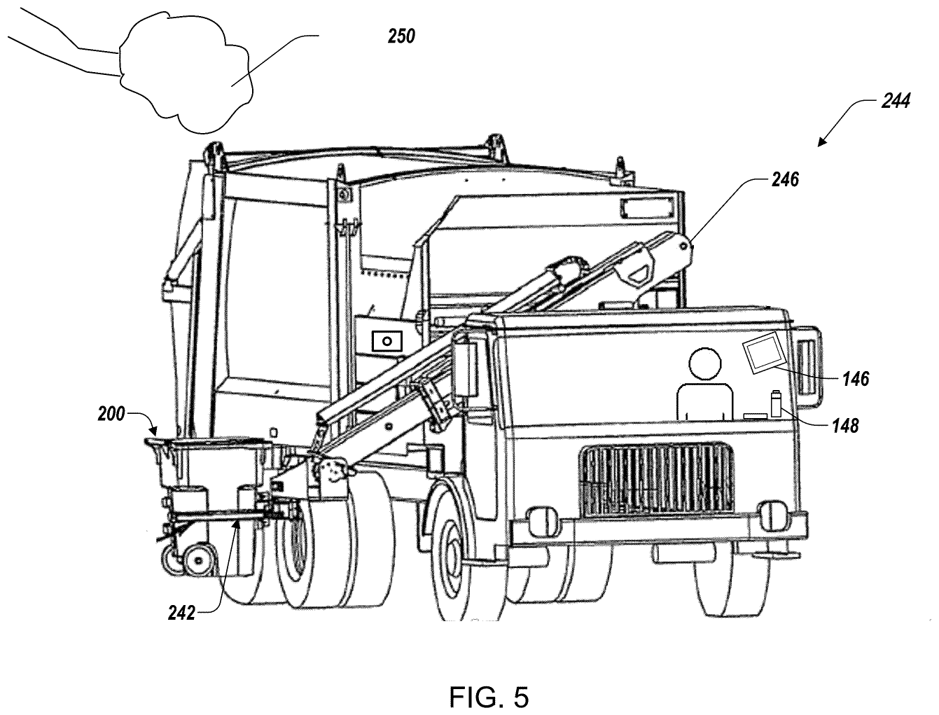

FIG. 5 illustrates a side-loading refuse vehicle with a grabber and lift arm according to some implementations. Grabber 242 of refuse loading system 244 is operable to couple with refuse container 200. Lift arm 246 is operable to lift refuse container 200 such that the contents of refuse container are emptied into the refuse vehicle. Object detection devices on the refuse vehicle can gather data regarding objects that may be in the path of the container or components of the refuse loading system during a loading cycle. Additional details and descriptions regarding the structure and operations of grabber 242 and lift arm 246 are provided in United States Publication No. US-2013/0039728, the entirety of which is incorporated herein by reference.

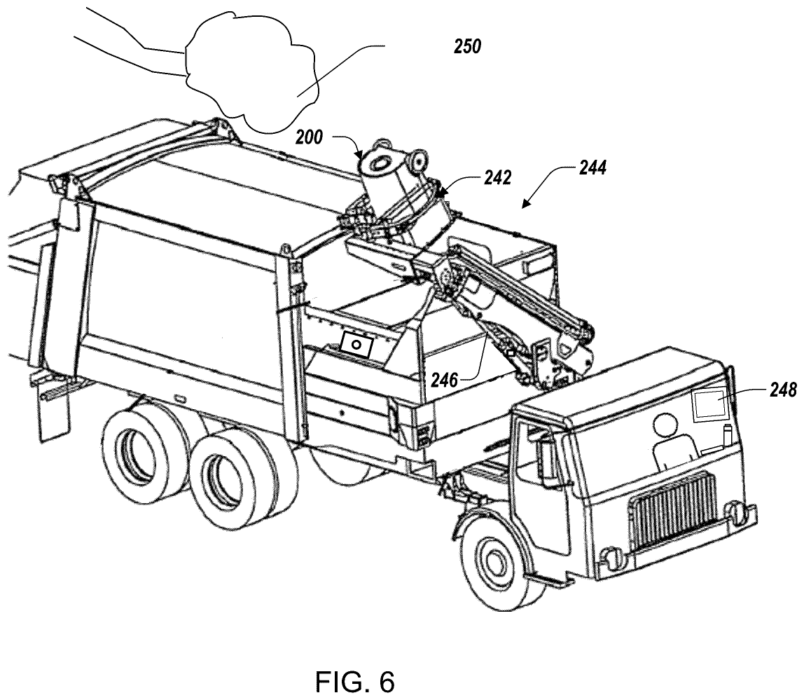

FIG. 6 illustrates the side-loading refuse vehicle of FIG. 5 with a grabber and lift arm during a loading cycle according to some implementations. Loader control system 248 can include a proportional control to operate lift arm 246 or other components of the refuse loading system at a reduced speed, adjustable by the operator. In this case, the operator may use proportional control to reduce speed of components of the lift mechanism while refuse container 200 and grabber 242 are close to tree limb 250.

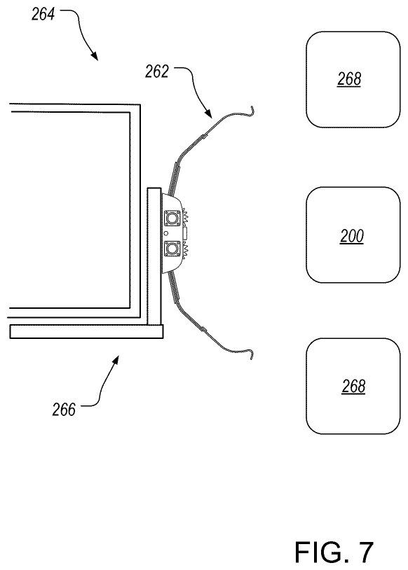

FIG. 7 is a top schematic view of a refuse loading system for an intermediate container according to some implementations. Grabber 262 of refuse loading system 264 is operable to couple with a target refuse container 200. Horizontal positioning system 266 is operable to extend grabber 262 to position grabber in front of target refuse container 200. Object detection devices (such as objection recognition sensors) on the refuse vehicle can gather data regarding objects that may be in the path of grabber 262 during capture of container 200, such as nearby containers 268.

FIG. 8 is schematic diagram of a refuse vehicle with proportional control and obstacle detection capabilities according to some implementations. Refuse vehicle 100 includes body components 300 that can be operated to perform various steps in collection or handling of refuse. Such body components include, for example, components of the refuse loading systems described above relative to FIGS. 1-7, such as grabbers, lift mechanisms, lift arms, and horizontal positioning systems. Refuse vehicle 100 also includes devices for sensing information about the refuse or body components that can be used in the operation of the vehicle to collect refuse and reporting information about the refuse or collection operations.

The body components 300 of the refuse vehicle 100 can include various components that are appropriate for the particular type of vehicle. For example, a garbage collection vehicle may be a truck with an automated side loader (ASL). Alternatively, the vehicle may be a front-loading truck, a rear loading truck, a roll-off truck, or some other type of garbage collection vehicle. A front-loading vehicle, for example, may include body components such as a pump, tailgate, packer, grabber, and so forth. A rear loading vehicle may include body components such as a pump, blade, tipper, and so forth. A roll-off vehicle may include body components such as a pump, hoist, cable, and so forth. Body components may also include other types of components that operate to bring garbage into a hopper (or other storage area) of a truck, compress and/or arrange the garbage in the storage area or body, and/or expel the garbage from the body.

Refuse vehicle 100 can include any number of sensors 302 that sense body component(s) and generate sensor data 304 describing the operation(s) and/or the operational state of various body components 300. Sensors 302 may be arranged in the body components 300, or in proximity to the body components 300, to monitor the operations of the body components 300. The sensors 302 emit signals that include the sensor data 304 describing the body component operations. These signals may vary appropriately based on the particular body component 300 being monitored. Sensors may also be arranged to provide sensor data 304 describing the position of external objects, such as a refuse container.

Sensors 302 can be provided on the vehicle body to evaluate cycles and/or other parameters of various body components. For example, the sensors 302 can measure the hydraulic pressure of various hydraulic components, and/or pneumatic pressure of pneumatic components. The sensors 302 can also detect and/or measure the particular position and/or operational state of body components such as the top door of a refuse collection vehicle, intermediate collection device, a lift arm, a refuse compression mechanism, a tailgate, and so forth, to detect events such as a lift arm cycle, a pack cycle, a tailgate open or close event, an eject event, tailgate locking event, and/or other body component operations.

In some implementations, the sensor data 304 may be communicated from the sensors 302 to an onboard computing device 306 in refuse vehicle 100. In some instances, the onboard computing device is an under-dash device (UDU), which may also include and/or be referred to as a “gateway.” Alternatively, the onboard computing device 306 may be placed in some other suitable location in or on the vehicle. The sensor data 304 may be communicated from the sensors 302 to the onboard computing device 306 over a wired connection (e.g., an internal bus) and/or over a wireless connection. In some implementations, a Society of Automotive Engineers standard J1939 bus in conformance with International Organization of Standardization (ISO) standard 11898 connects the various sensors 302 with the onboard computing device 306. In some implementations, a Controller Area Network (CAN) bus connects the various sensors 302 with the onboard computing device 306. In some implementations, the sensors 302 may be incorporated into the various body components 300. Alternatively, the sensors 302 may be separate from the body components 300. In some implementations, the sensors 302 digitize the signals that communicate the sensor data 304 before sending the signals to the onboard computing device 306, if the signals are not already in a digital format.

The analysis of the sensor data 304 can be performed at least partly by the onboard computing device 306, e.g., by processes that execute on the processor(s) 308. For example, the onboard computing device 306 may execute processes that perform an analysis of the sensor data 304 to detect the presence of a triggering condition, such as a lift arm being in a particular position in its cycle to empty a container into the hopper of the vehicle.

The onboard computing device 306 can include one or more processors 308 that provide computing capacity, data storage 310 of any suitable size and format, and network interface controller(s) 311 that facilitate communication of the onboard computing device 306 with other device(s) over one or more wired or wireless networks.

Refuse vehicle 100 includes a body controller 312. The body controller 312 manages and/or monitors various body components of the vehicle. The body controller 312 of a vehicle can be connected to multiple sensors (e.g., sensors 302) in the body of the vehicle. The body controller 312 can transmit control signals 313 over the J1939 network, or other wiring on the vehicle. In some instances, these signals from the body controller 312 can be received by the onboard computing device 306 that is monitoring the J1939 network. In some implementations, body controller 312 controls movement of a components of a refuse loading system, including components of a grabber, lift mechanism, or horizontal positioning system.

In FIG. 8, body controller 312 is a separate component from onboard computing device 306. A body controller can, however, be integrated into an onboard computing device. In some implementations, a refuse collection vehicle includes multiple body controllers, with each controlling one or more of the various body components on the vehicle.

In some implementations, the onboard computing device 306 is a multi-purpose hardware platform. The onboard computing device 306 can include a UDU (Gateway) and/or a window unit (WU) (e.g., camera) to record video and/or audio operational activities of the vehicle. The onboard computing device hardware subcomponents can include, but are not limited to, one or more of the following: a CPU, a memory or data storage unit, a CAN interface, a CAN chipset, NIC(s) such as an Ethernet port, USB port, serial port, I2c line(s), and so forth, I/O ports, a wireless chipset, a global positioning system (GPS) chipset, a real-time clock, a micro SD card, an audio-video encoder and decoder chipset, and/or external wiring for CAN and for I/O. The onboard computing device 306 can also include temperature sensors, battery and ignition voltage sensors, motion sensors, CAN bus sensors, an accelerometer, a gyroscope, an altimeter, a GPS chipset with or without dead reckoning, and/or a digital can interface (DCI). The DCI cam hardware subcomponent can include the following: CPU, memory, can interface, can chipset, Ethernet port, USB port, serial port, I2c lines, I/O ports, a wireless chipset, a GPS chipset, a real-time clock, and external wiring for CAN and/or for I/O. In some implementations, the onboard computing device 306 is a smartphone, tablet computer, and/or other portable computing device that includes components for recording video and/or audio data, processing capacity, transceiver(s) for network communications, and/or sensors for collecting environmental data, telematics data, and so forth.

In some implementations, one or more cameras 314 can be mounted on the refuse vehicle 100 or otherwise present on or in the refuse vehicle 100. The camera(s) 314 each generate image data 316 that includes one or more images of a scene external to and in proximity to the vehicle 100 and/or image(s) of an interior of the vehicle 100. In some implementations, one or more cameras 314 are arranged to capture image(s) and/or video of a container 200 before, after, and/or during the operations of body components 300 to empty the container 200 into the hopper of the refuse vehicle 100. For example, for a front-loading vehicle, the camera(s) 314 can be arranged to image objects dumped into the hopper of the vehicle. As another example, for a side loading vehicle, the camera(s) 314 can be arranged to image objects to the side of the vehicle, such as a side that mounts the ASL to lift containers. In some implementations, camera(s) 314 can capture video of a scene external to and in proximity to the refuse vehicle 100.

In some implementations, the camera(s) 314 are communicably coupled to a graphical display 318 to communicate images and/or video captured by the camera(s) 314 to the graphical display 318. In some implementations, the graphical display 318 is placed within the interior of the refuse vehicle 100. For example, the graphical display 318 can be placed within the cab of refuse vehicle 100 such that the images and/or video can be viewed by an operator of the refuse vehicle 100 on a graphical display 318. In some implementations, the graphical display 318 includes a screen and images and/or video can be viewed by an operator of the vehicle 100 on the screen. In some implementations, the graphical display 318 is a heads-up display that projects images and/or video onto a windshield of the refuse vehicle 100 for viewing by the operator. In some implementations, the images and/or video captured by the camera(s) 314 can be communicated to a graphical display 318 of the onboard computing device 306 in the vehicle 100. Images and/or video captured by the camera(s) 314 can be communicated from the sensors to the onboard computing device 306 over a wired connection (e.g., an internal bus) and/or over a wireless connection. In some implementations, a J1939 bus connects the camera(s) 314 with the onboard computing device. In some implementations, the camera(s) 314 are incorporated into the various body components. Alternatively, the camera(s) 314 may be separate from the body components.

Object detection devices 330 are coupled to vehicle 100. Object detection devices 330 can be, in various implementations, an objection recognition device, a camera, or a proximity sensor. Object detection devices 330 are communicatively coupled to the onboard computing device 306. Onboard computing device 306 receives object data 332 from object detection devices 330. Object detection devices 330 can, in various implementations, detect and/or image potential obstacles of around refuse vehicle 100.

The controllers can process information received from object detection devices 330 and responsively control operation of refuse vehicle 100. For example, in response to the onboard computing device 306 receiving a signal from an object detection device indicating the presence of objects proximate the refuse vehicle 100, the body controller 312 can send instructions to one or more of the body components 300 to alter operation of a refuse loading system.

In some implementations, the analysis of object data 332, image data 316, and/or sensor data 304 is performed at least partly on the onboard computing device 306, operating for example as an edge device. For example, the onboard computing device 306 may include a processor with a central processing unit (CPU), a digital signal processor (DSP), a graphics processing unit (GPU), and/or a neural network processing unit that operate to analyze the radiation, image and/or sensor data on the onboard computing device 306.

In the example of FIG. 8, signal(s) are sent to the computing device(s) 336, and image(s) are presented in a user interface 338 of a monitor application 340 executing on the remote computing device(s) 336. In some implementations, object data 332, sensor data 304 and/or other information is analyzed on the onboard computing device 306 to provide information about objects around the refuse loading system. The system (e.g., onboard computing device) can determine whether certain objects are, for example, potential obstacles for operation of the refuse loading system. Captured image(s) and other information can be communicated to the computing device(s) 336 and presented in the user interface 338 of the monitor application 340. An operator can examine the images and data using the monitor application 340. Based on information received via the system (and/or, direct observations by the operator of the refuse loading system and its surroundings), the operator can use proportional control button 342 to control the speed of components of the refuse loading system. In some implementations, upon detecting a potential obstacle, the system automatically limits the speed of the refuse loading system components, regardless of whether those components are being controlled as part of automatic loading cycle or based on the operator's actuation of the proportional control button.

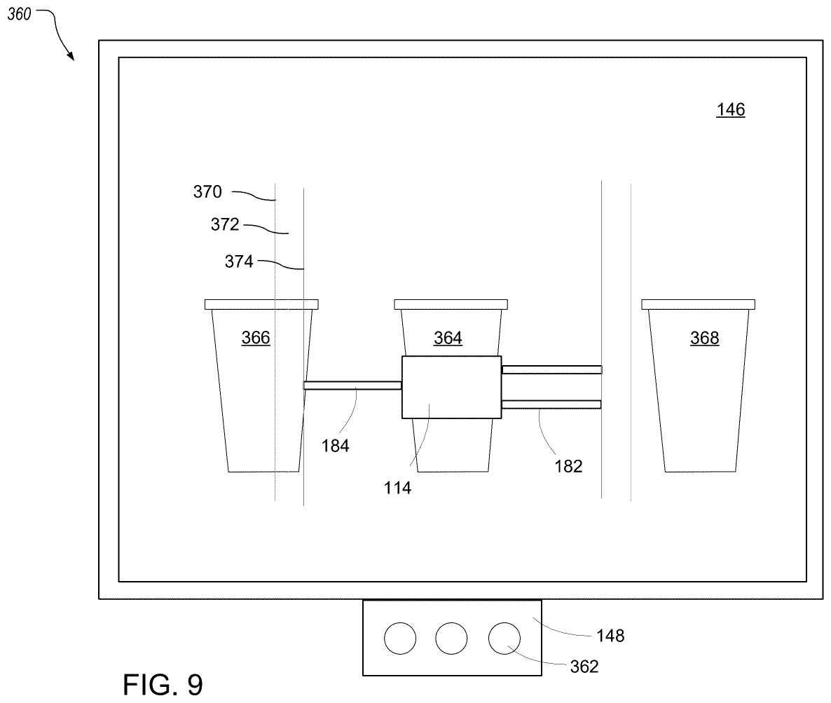

FIG. 9 illustrates a control panel for an operator to control a refuse loading system according to some implementations. Control panel 360 includes display device 146 and button panel 148. Button panel 148 includes proportional control button 362.

In this example, the operator can view on display device 146 an image of the refuse loading system in relation to a target container and potential obstacles. The image can include (or be generated from) camera data, or be generated from other information, such as object detection devices or proximity sensors. As shown, the displayed image includes a representation of refuse loading system 114 (including gripper arm assemblies 182 and 184), target container 364, nearby container 366 (in front of target container 364), and nearby container 368 (to the rear of target container 364). The displayed image also includes collision lines on either side the grabber. In this example, the collision lines 370 indicate that the object is not in the path of the refuse loading system. The collision lines 372 indicate that the object is close to the path of the refuse loading system. The collision lines 374 indicate that the object is in the path of the refuse loading system. In FIG. 9, nearby container 366 is in the path of refuse loading system 114, while nearby container 368 is clear of the path of refuse loading system 114.

Upon recognizing that nearby container 366 is in the path of the refuse loading system, the operator can activate proportional control button 362 for at least a portion of the loading cycle to reduce the speed of the grabber, the horizontal position system, and/or the container lift. The display can include a proportional control indicator. The proportional control indicator 376 can provide a graphical representation of the level of proportional control (e.g., 20% of full speed, 60% of full speed, etc.).

In this example, proportional control 362 is in the form of a button. Other types of control devices, such as a joystick, can also be used to provide proportional control.

In the example described above with respect to FIG. 9, the system provides information about the position of the refuse loading system and/or potential obstacles by way of a display screen (which may be, for example, in the cab of the vehicle.). In other implementations, other devices can be used to provide an operator with information about objects around the vehicle or the position or state of components of the refuse loading system. For example, the system may provide an array of light indicators (e.g., colored lights) to indicate potential obstacles. As another example, the system can provide audible signal (e.g., an audible warning, a buzzer) to an indicate a potential obstacle. In some implementations, the operator directly views the refuse loading system and surrounding objects while using a proportional control to perform a loading cycle.

In the example shown in FIG. 9, the button panel is coupled to the display. The proportional button can, however, be separate from (or separable from) the display.

Control units and/or computing devices as described herein can include or use one or more computing systems. FIG. 10 depicts an example computing system, according to implementations of the present disclosure. The system 600 may be used for any of the operations described with respect to the various implementations discussed herein. The system 600 may include one or more processors 610, a memory 620, one or more storage devices 630, and one or more input/output (I/O) devices (not shown) controllable via one or more I/O interfaces 640. The various components 610, 620, 630, or 640 may be interconnected via at least one system bus 660, which may enable the transfer of data between the various modules and components of the system 600. In some implementations, a control system may be coupled to an operator display and control panel (for example, located in a cab of the vehicle.)

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs). The system 600 may include one or more I/O devices.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, DRAM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

Implementations may be employed with respect to any suitable type of RCV, with any suitable type of body and/or hopper variants. For example, the RCV may be an automated side loader vehicle, such as described above relative to FIGS. 1 and 2. As another example, the RCV can be a commercial front loader (e.g., for dumpster type containers.) As another example, the RCV can be a residential front loader. A front loader can be provided with or without an intermediate collection device. The intermediate collection device can be used, for example, to collect residential-sized containers. In other implementations, the refuse vehicle may be a front-loading truck, a rear loading truck, a roll off truck, or some other type of garbage collection vehicle.

As used herein, a “potential obstacle” includes any object (non-living, living, or a combination of both) that may be in the path of one or more components of a mechanism during operation. “Potential obstacles” include objects the system determines might collide with a component of the system during operation, as well as objects that are certain to collide with a component of the system during operation. Examples of potential obstacles include other refuse containers, vehicles, tree limbs, shrubs, signposts, mailboxes, persons, and animals.

As used herein, a “drive unit” includes any device, mechanism, or system that imparts force to mechanically drive one or more components. Examples of a drive unit include a hydraulic motor, an electric motor, or an engine. A driver may also include gearboxes, belts, chain drives, or other power transmission devices.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

1. A system for collecting refuse, comprising:
a refuse loading system configured to couple to a refuse collection vehicle and to load refuse into the refuse collection vehicle, the refuse loading system comprising:
a container-holding mechanism operable to hold a refuse container; and
a positioning system operable to position the container-holding mechanism relative to the refuse collection vehicle; and
a control system comprising:
a proportional control device;
at least one processor; and
memory communicably coupled to the at least one processor, the memory storing instructions which, when executed, cause the at least one processor to perform operations comprising:
receiving, from an operator, via the proportional control device, an input to control movement of one or more components of the refuse loading system; and
responsive to receiving the input from the operator via the proportional control device, operating the container-holding mechanism and the positioning system to perform a portion of a refuse loading cycle.

2. The system of claim 1, wherein the portion of the refuse loading cycle comprises one of a coordinated dump and auto-lift operation.

3. The system of claim 1, wherein:
the container-holding mechanism comprises at least one of a container-lifting device or a grabber; and
the control system is configured to control the speed of one or more components of the container-holding mechanism responsive to receiving the input via the proportional control device.

4. (canceled)

5. The system of claim 1, wherein:
the positioning system comprises a horizontal positioning system; and
the control system is configured to control the speed of one or more components of the horizontal positioning system responsive to receiving the input via the proportional control device.

6. (canceled)

7. The system of claim 1, wherein movement of one or more components of the container-holding mechanism during the portion of the refuse loading cycle is coordinated with positioning of the container-holding mechanism by the positioning system.

8. The system of claim 1, wherein the memory further stores instructions executable by the processor to perform:
receiving, from the operator, via the proportional control device, a change in input to control movement of one or more components of the refuse loading system; and
responsive to receiving the change in input, adjusting a speed of one or more components of the container-holding mechanism and one or more components of the positioning system.

9-12. (canceled)

13. The system of claim 1, wherein:
the container-holding mechanism comprises at least one of a grabber or a container lift mechanism;
the positioning system comprises at least one of a lifting arm or a horizontal positioning system; and
the memory further stores instructions executable by the processor to perform:
adjusting the speed of one or more components of the container-holding mechanism and the speed of one or more components of the positioning system in response to the input from the operator via the proportional control device.

14. (canceled)

15. The system of claim 1, further comprising:
one or more sensors communicatively coupled to the control system, the one or more sensors configured to detect objects around the refuse collection vehicle;
wherein the memory further stores instructions executable by the processor to perform:
receiving data from at least one of the sensors about one or more objects detected around the refuse collection vehicle;
responsive to receiving the data from the at least one sensor about one or more objects detected around the refuse collection vehicle, determining whether at least one of the objects is a potential obstacle for the refuse container or a component of the refuse loading system during the portion of the refuse loading cycle;
responsive to determining that at least one of the objects is a potential obstacle, performing at least one of:
activating a reduced speed mode of the refuse loading system; or
inhibiting movement of one or more components of the refuse loading system for at least a portion of the refuse loading cycle; and
responsive to determining that the refuse container or component of the refuse loading system is clear of the potential obstacle, increasing the speed of one or more components of the refuse loading system.

16-23. (canceled)

24. A system for collecting refuse, comprising:
a refuse loading system configured to couple to a refuse collection vehicle and to load refuse into the refuse collection vehicle, the refuse loading system comprising one or more sensors configured to detect objects around the refuse collection vehicle; and
a control system comprising:
at least one processor; and
memory communicably coupled to the at least one processor, the memory storing instructions which, when executed, cause the at least one processor to perform operations comprising:
receiving data, from at least one sensor of the one or more sensors, about one or more objects detected around the refuse collection vehicle;
responsive to receiving the data from the at least one sensor about one or more objects detected around the refuse collection vehicle, determining whether at least one of the objects is a potential obstacle for a refuse container or a component of the refuse loading system during a portion of a refuse loading cycle; and
responsive to determining whether at least one of the objects is a potential obstacle for the refuse container or a component of the refuse loading system, adjusting a speed of at least one component of the refuse loading system during the portion of the refuse loading cycle.

25. The system of claim 24, wherein at least one of the sensors comprises at least one of an object recognition sensor or a camera.

26. (canceled)

27. The system of claim 24, wherein the portion of the refuse loading cycle comprises a coordinated dump and auto-lift operation.

28. The system of claim 24, wherein adjusting a speed of at least one component during the portion of the refuse loading cycle comprises at least one of:
reducing the speed of at least one component of a container-lifting device;
reducing the speed of at least one component of a grabber; or
reducing the speed of at least one component of a horizontal positioning system.

29. (canceled)

30. (canceled)

31. The system of claim 24, wherein the memory further stores instructions executable by the processor to perform:
responsive to determining that at least one of the objects is a potential obstacle, activating a reduced speed mode of the refuse loading system, wherein activating the reduced speed mode comprises at least one of (i) limiting operation of the refuse loading system to input from a proportional control device or (ii) reducing the speed of one or more components for at least a portion of the refuse loading cycle.

32. (canceled)

33. (canceled)

34. The system of claim 24, wherein, responsive to determining that at least one of the objects is a potential obstacle, the memory further stores instructions executable by the processor to perform at least one of:
inhibiting movement of one or more components of the refuse loading system for at least a portion of the refuse loading cycle; or
disabling movement of one or more components of the refuse loading system for at least a portion of the refuse loading cycle.

35. (canceled)

36. The system of claim 24, wherein the memory further stores instructions executable by the processor to perform:
determining whether a refuse container or component of the refuse loading system is clear of the potential obstacle; and
responsive to determining that the refuse container or component of the refuse loading system is clear of the potential obstacle, increasing the speed of one or more components of the refuse loading system.

37. The system of claim 24, wherein the potential obstacle is at least one of: an object on the ground, an overhead object, or a moving object.

38. (canceled)

39. (canceled)

40. The system of claim 24, wherein:
the control system further comprises a proportional control device; and
adjusting a speed of at least one component during the portion of the refuse loading cycle comprises:
receiving, from an operator, via the proportional control device, an input to control movement of one or more components of the refuse loading system; and
responsive to receiving the input from the operator via the proportional control device, operating the refuse loading system to perform a portion of a refuse loading cycle.

41. The system of claim 24, wherein movement of one or more components of a container-holding mechanism of the refuse loading system during the portion of the refuse loading cycle is coordinated with positioning of the container-holding mechanism by a positioning system of the refuse loading system.

42. (canceled)

43. The system of claim 24, wherein the control system is configured to provide, to the operator, a warning of potential obstacles for the refuse loading system.

44. A method for loading refuse into a refuse collection vehicle, the method performed by at least one processor, the method comprising:
receiving data, from at least one sensor, about one or more objects detected around the refuse collection vehicle;
responsive to receiving the data from the at least one sensor about one or more objects detected around the refuse collection vehicle, determining whether at least one of the objects is a potential obstacle for a refuse container or a component of the refuse loading system during a portion of a refuse loading cycle; and
responsive to determining whether at least one of the objects is a potential obstacle for the refuse container or a component of the refuse loading system, adjusting a speed of at least one component of the refuse loading system during the portion of the refuse loading cycle.
